(19) United States
(12) Patent Application Publication
(10) Pub. No.: US 2006/0248192 A1
(43) Pub. Date: Nov. 2, 2006

(54) Method for pulling images from the internet for viewing on a remote digital display

(76) Inventors: Stanley S. Morris III, Lake Forest, CA (US); Richard Hamm, Huntington Beach, CA (US)

Correspondence Address: MORLAND C FISCHER, 2030 MAIN ST, SUITE 1050, IRVINE, CA, 92614, US

(21) Appl. No.: 11/118,009

(22) Filed: Apr. 29, 2005

(51) Int. Cl. G06F 15/173

(52) U.S. Cl. 709/226

(57) ABSTRACT

A method by which a digital display having internet capability and a memory in which an original set of digital images is stored and displayed (e.g., as a continuously running slide show) automatically pulls down new digital images across the internet from at least one remote web server so that the new digital images can be shown in place of the original set of digital images without gaining physical access to the digital display. The new digital images on the remote web server are assigned unique internet URLs that resolve to a compatible image format and correspond to internet URLs that are associated with the original set of digital images. If a new digital image has an appropriate URL, then such new digital image is retrieved by the digital display to be displayed in a place of a respective one of the original digital images. Otherwise, a predetermined default image will be displayed on the digital display.

### BACKGROUND OF THE INVENTION

1. Field of the Invention

This invention relates to a method by which a digital display having a memory capability can automatically pull and display image, audio and other digital content from a remote web server via the internet by means of assigning unique internet URLs to the digital content that resolves to a compatible (e.g., JPEG) format image.

2. Background Art

Methods are known by which individuals can have their digital images viewed on a remote digital display. In general, to accomplish the foregoing, the individual must first subscribe to a suitable service which requires payment of a (e.g., monthly) service charge. The individual can then upload his images to a website controlled by the service. However, the individual is usually obligated to use a network established by the service. In this case, the remote digital display connects to the website of the service via the internet, and the service causes the digital images to be pushed to the display. However, only a limited number of images are typically sent once a day for viewing on the remote digital display.

Such a method of transmitting digital images from the website of a service is inherently static in nature. That is, only a certain number of images can be sent to the remote display at any time due to bandwidth limitations, and such digital image transfer usually occurs only one time during any day. Consequently, the individual cannot send all of his digital images to the remote display on a continuous basis. Moreover, if the number of images to be viewed is very large, and the storage capacity of the service is limited or the time to transfer an image is relatively long, the individual may require more than a single day to complete the transfer. Thus, it can be appreciated that employing an independent service as a link to enable digital images to be sent from an individual to a remote display can be expensive, inefficient and ineffective, especially in situations where large amounts of video image data must be transmitted in a short amount of time.

### SUMMARY OF THE INVENTION

A method is described herein by which a digital display connects to at least one remote web server via an internet connection so that the digital display can retrieve one or more images from the web server through the internet for the purpose of viewing on the digital display on an as-needed basis. The digital display has the capability to store a series of slides having associated URLs and default images so that an ongoing slide show can be viewed. The digital display is adapted to pull down new digital images that are captured by an individual so that the new images can be shown in place of corresponding slides of the slide show without direct intervention on the part of the individual.

To accomplish the foregoing, the remote web server should be capable of returning the new digital images to the display as a compatible format image. The new digital images on the remote web server are assigned unique internet URLs that correspond with the URLs that are associated with the original series of slides. The particular web addresses that are assigned to the new images allow the digital display to point to and automatically pull the images down one at a time. The new digital images that are captured by the user can be uploaded from a digital camera by means of a personal computing device to a photo sharing service or similar website. The URLs that are assigned to the new digital images enable the original slides of the slide show to be replaced with the new images on a continuous basis any time of day and without limitation as to number.

More particularly, each slide of the slide show having an associated URL is retrieved from the memory of the digital display. If there are no new replacement digital images or if the digital display is not connected to the internet, then the original slide show continues to be displayed. If a new web image does not have a corresponding URL, then a predetermined default image will be displayed. However, if a new web image is identified which has a corresponding URL, then an attempt is made by the digital display to retrieve the new image from the internet. If the retrieved new image is valid, then it is shown in place of the image of the original slide. The new image is displayed for a predetermined time until the next slide from the slide show is retrieved and a determination is made whether to show the new digital image in place thereof.

### BRIEF DESCRIPTION OF THE DRAWINGS

FIG. 1 is a block diagram to illustrate a preferred system for automatically pulling new digital images across the internet to be shown in place of original slide show images that are viewed on a remote digital display; and

FIG. 2 is a flow chart to illustrate the method steps of this invention for pulling the new digital images to the remote digital display by way of the internet and at least one web server.

### DESCRIPTION OF THE PREFERRED EMBODIMENT

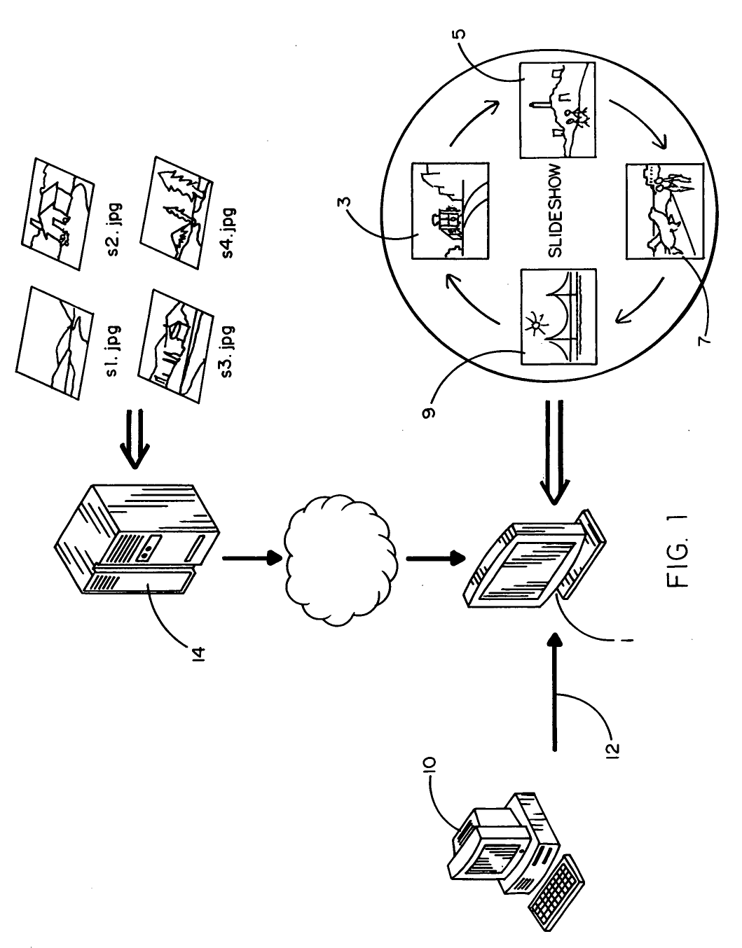

Referring to the drawings, FIG. 1 shows a digital display 1 having a local storage, whereby the display is capable of storing a plurality of digital images and associated information so that the images can be sequentially displayed in a predetermined order. The digital display 1 may be any suitable device with storage and internet compatibility such as that sold commercially as MEMORY FRAME by Pacific Digital Corporation of Irvine, Calif. By way of example, digital images, such as photographs, may be prepared and uploaded to display 1 from a workstation 10 by way of a USB or ethernet link 12. The digital display 1 may be conveniently located on a desk, table, or similar stand, in a home or office to display the stored digital images one at a time at a preprogrammed rate. In this case, the digital images are displayed as slides 3, 5, 7 and 9 in a continuously running slide show.

Information about each slide 3, 5, 7 and 9 is stored in the local storage of the digital display 1. Such information includes a respective URL for each slide, a default image, and a background color.

From time-to-time, it may be desirable for a user to be able to show new images in place of the content represented by the slides 3, 5, 7 and 9 while at a remote location and without having direct physical access to the digital display 1. For example, while traveling on a vacation or while attending a trade show, the user may wish to change the slide show to be viewed on digital display 1 so that those at home or the office will be able to see selected images that are captured by the user in substantially real time.

The improvement described herein is a method by which new digital images can be pulled down, one at a time, instead of all at once and on an as-needed basis from the internet to be substituted for the images that are initially stored in the digital display in order to vary the content of the slide show to be viewed at the home or office. By virtue of the foregoing, a dynamic method is available by which any number of new digital images can be retrieved from the internet at any time of day or night without requiring the service of a third party and the use of its website. This represents an improvement over the commercially available static techniques where images are pushed from the website of a service to a digital display about once each day.

The foregoing dynamic method is accomplished by the digital display 1 connecting to at least one remote web server 14 at an internet connection so that the digital display 1 is adapted to retrieve digital images from across the internet. That is, more than the single web server 14 as shown in FIG. 1 may be utilized herein. To enable such images to be selectively identified and pulled down from server 14 to the digital display 1, it is necessary for the user to assign a unique web address to each new image which corresponds with the URL of the original digital content represented by slides 3, 5, 7 and 9. In addition, the web server 14 should be capable of returning a compatible format image (e.g., such as the JPEG format image) to the display 1. However, it is to be expressly understood that the method disclosed herein is also capable of supporting other format images, such as GIF, PNG, TIFF or BMP. By way of example only, four new JPEG digital images are designated in FIG. 1 with the jpg extensions s1.jpg, s2.jpg, s3.jpg and s4.jpg to correspond with the four slides of the slide show. Nevertheless, any number of compatible format images can be retrieved as necessary, rather than the four images illustrated in FIG. 1. Moreover, a jpg extension is not required for the server 14 to return a JPEG image.

Each new digital image on the server 14 is assigned a unique internet URL that resolves to a compatible format image. In the example of FIG. 1, the URLs that are associated with the new digital images are http://www.URL.com/s1.jpg, . . . , http://www.URL.com/s4.jpg. To this end, the user can employ a digital camera to capture the new images to be displayed. The new images are uploaded from the digital camera by means of a personal computing device to a photo sharing service or similar website. A readily-available web based program can be accessed to assign the different web addresses (such as those just listed) to the images. These different web addresses enable the digital display 1 to identify and pull the new digital images across the internet from the web server 14 to replace corresponding slides being shown on the digital display 1.

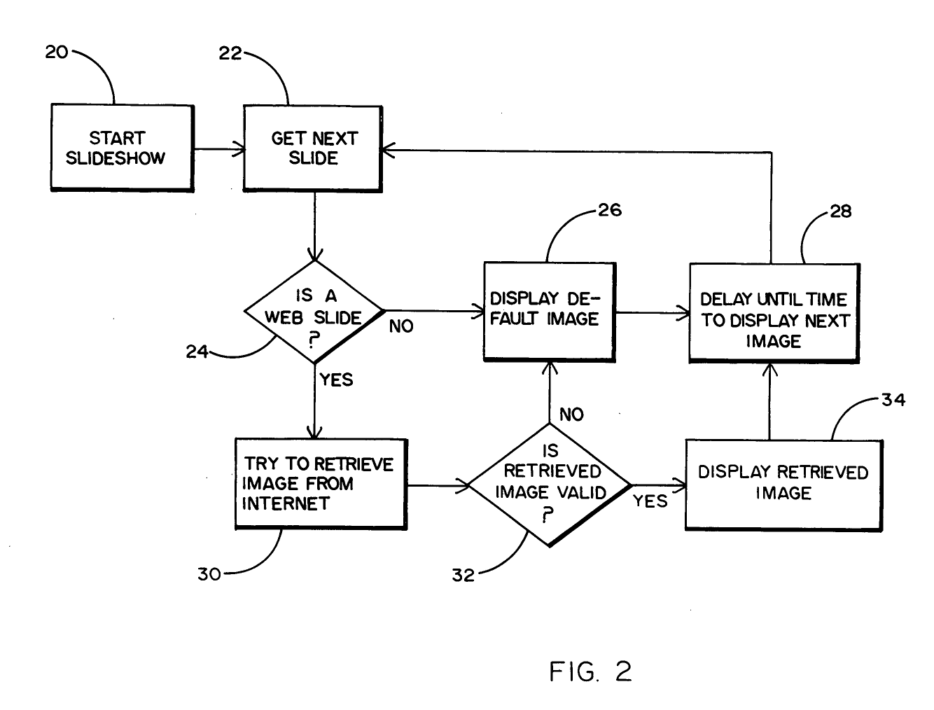

Details of the preferred method of this invention are now disclosed while referring to FIG. 2 of the drawings, wherein the digital display 1 automatically pulls down digital image content from the remote web server 14 under the control of software that resides in the display. More particularly, the digital display 1 actively seeks to locate and pull down new content across the internet so that the original slides 3, 5, 7 and 9 of the slide show of FIG. 1 can be automatically replaced on a continuous basis without the user having physical access to the display. In this same regard, if no new digital images have been created by the user or if the digital display 1 is not connected to the internet, then the existing slide show continues to be displayed.

The slide show to be viewed on the digital display 1 begins at step 20. The first slide (designated 3 in FIG. 1) of the slide show is retrieved from the memory of the digital display 1 during step 22. Before the image of the first slide 3 is displayed, the digital display 1 determines if an image URL is associated with the slide. Next, at step 24, an inquiry is made as to whether there is a new web image having a corresponding URL. If the new web image has not been assigned a corresponding URL that resolves to a compatible format image, then a default image that is stored in digital display 1 is displayed during step 26. As earlier indicated, the default image to be displayed can be any suitable image or just a background color that is initially stored in the digital display 1 with other information relating to the particular slide to be retrieved.

The default image associated with the original slide 3 is displayed for a predetermined time during step 28. Once the display time expires, the method returns to step 22 where the next slide of the slide show (designated 5 in FIG. 1) is displayed. Another inquiry is made during step 24 as to whether there is a new web image having a unique URL that corresponds to the URL of the slide 5. In this case, if a web image having a suitable URL is now located, a request is sent by the digital display 1 to the server 14 during step 30 to retrieve (i.e., pull down) the web image from the internet.

Next, during step 32, an inquiry is made as to whether the content retrieved from the internet can be treated as a valid image that is suitable for display. If the content is not valid and fails (e.g., such as if a URL has been assigned that resolves to an html page description), then the method returns to step 26 where the aforementioned default image is displayed. However, if the retrieved content is determined to be a valid image, then during step 34, the new web image will be displayed in place of the former image of the slide show. The new image may be stored in the digital display 1 if sufficient storage capacity is available. The method then returns to step 28 where the replacement image that has been pulled down from the internet is displayed for a predetermined time until the next slide from the slide show is accessed in the manner previously described when referring to step 22.

FIGS. 1 and 2 of the drawings represent the preferred method of this invention. That is to say, the original slides 3, 5, 7 and 9 and the replacement digital content to be viewed on digital display 1 have been described as containing digital images. However, without departing from the scope of this invention, it is to be understood that the information content of the original slides and their internet replacements need not be limited solely to image content. For example, the slides can contain an audio clip as well as a variety of other visual and digital content (e.g., indicative of whether maps around the country or as part of a music and art show to be viewed and/or heard). What is more, the method disclosed herein can be accomplished with displays other than then the desk or tabletop digital display that is shown in FIG. 1. By way of example, such digital display can be replaced by an LCD flat panel or billboard-type display so as to be located against a wall or used as signage to convey a variety of different messages.

We claim:

1. A method by which new digital images are shown in place of an original set of digital images that is stored in and displayed on a remote digital display without gaining physical access to the remote digital display, said method comprising the steps of:
uploading one or more new digital images to at least one web server;
assigning an internet URL to each of the new digital images that resolves to a compatible format image;
associating an internet URL with each of the original set of digital images;
connecting the remote digital display to the web server at an internet connection; and
pulling said one or more new digital images across the internet from said at least one web server to the remote digital display to be shown in place of corresponding ones of the original set of digital images depending upon the internet URLs assigned to said new digital images and the internet URLs associated with the original set of digital images.

2. The method recited in claim 1, including the additional step of said at least one web server returning the new digital images to the digital display in said compatible format image.

3. The method recited in claim 2, wherein said compatible format image is a JPEG format image.

4. The method recited in claim 1, wherein the internet URLs assigned to the new digital images correspond to the internet URLs associated with the original set of digital images.

5. The method recited in claim 1, including the additional step of the video display displaying a predetermined default image in the event that a corresponding new digital image does not have an internet URL that resolves to a compatible format image.

6. The method recited in claim 1, including the additional step of the video display continuing to display the original set of digital images in the event that the digital display is not connected to the remote web server.

7. The method recited in claim 1, including the additional step of storing in the video display the new digital images that are pulled across the internet from the at least one web server and shown in place of the original set of digital images.

8. The method recited in claim 8, including the additional step of displaying each of the original set of digital images and the replacement new digital images sequentially as a series of slides.

9. The method recited in claim 8, including the additional step of displaying each of the original set of digital images and the replacement new digital images for a predetermined time.

10. The method recited in claim 8, wherein at least some of the series of slides which contains the original set of digital images also contains audio content.
